(19) United States
(12) Patent Application Publication
(10) Pub. No.: US 2026/0173124 A1
(43) Pub. Date: Jun. 18, 2026

(54) DISTRIBUTED CENTRAL UNIT CONTROL PLANE RESILIENCY WITH OPTIMIZED RESOURCE ALLOCATION

(71) Applicant: NOKIA SOLUTIONS AND NETWORKS OY, Espoo (FI)

(72) Inventors: Sankaran BALASUBRAMANIAM, Bangalore (IN); Andres ARJONA, Tokyo (JP); Shehzad Ali ASHRAF, Munich (DE)

(21) Appl. No.: 19/119,817

(22) PCT Filed: Sep. 29, 2023
(86) PCT No.: PCT/EP2023/077087

§ 371 Date: Apr. 10, 2025

(30) Foreign Application Priority Data
Oct. 14, 2022 (IN) 202241058830

(51) Int. Cl. H04W 72/52; H04W 24/04; H04W 28/08; H04W 88/08

(52) U.S. Cl. CPC H04W 72/52; H04W 24/04; H04W 28/0835; H04W 88/085

(57) ABSTRACT

Various example embodiments relate to devices, methods, apparatuses and computer readable media for distributed central unit control plane (CU-CP) resiliency with optimized resource allocation in a split radio access network (RAN) architecture. A first CU-CP node in a radio access network may be configured to send a capacity poll request to one or more second CU-CP nodes in the radio access network configured as standby CU-CP nodes for the first CU-CP node, receive from the one or more second CU-CP nodes a capacity poll response comprising capacity information of the one or more second CU-CP nodes, and allocate at least one distributed unit associated with the first CU-CP node to one of the one or more second CU-CP nodes at least based on the capacity information of the one or more second CU-CP nodes.

### TECHNICAL FIELD

Various example embodiments described herein generally relate to communication technologies, and more particularly, to devices, methods, apparatuses and computer readable media for distributed central unit control plane (CU-CP) resiliency with optimized resource allocation in a split radio access network (RAN) architecture.

### BACKGROUND

Certain abbreviations that may be found in the description and/or in the figures are herewith defined as follows:
AMF Access and Mobility Management Function
CP Control Plane
CU Central Unit
DU Distributed Unit
E1 Interface between CU-CP and CU-UP
F1 Interface between CU and DU
F1-C F1 Control plane
F1-U F1 User plane
gNB next generation Node-B
NG-RAN Next Generation Radio Access Network
RRC Radio Resource Control
TAI Tracking Area Identity
UE User Equipment
UP User Plane
Xn Interface between NG-RAN Nodes

Network resiliency refers to ability of the network to provide an acceptable level of services to users despite any faults or outages. In a radio access network (RAN) e.g. a next generation radio access network (NG-RAN), an active base station e.g. a next generation Node-B (gNB) may be configured with a standby gNB to ensure the network resiliency. When the active gNB is out of service due to for example planned downtime, disturbances, attacks, or natural disasters, the standby gNB can be activated to provide services to users substituting for the out-of-service gNB.

### SUMMARY

A brief summary of example embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, an example embodiment of a first central unit control plane (CU-CP) node in a radio access network is provided. The first CU-CP node may comprise at least one processor and at least one memory storing instructions. The instructions may, when executed by the at least one processor, cause the first CU-CP node at least to send a capacity poll request to one or more second CU-CP nodes in the radio access network configured as standby CU-CP nodes for the first CU-CP node, receive from the one or more second CU-CP nodes a capacity poll response comprising capacity information of the one or more second CU-CP nodes, and allocate at least one distributed unit associated with the first CU-CP node to one of the one or more second CU-CP nodes at least based on the capacity information of the one or more second CU-CP nodes.

In a second aspect, an example embodiment of a second central unit control plane (CU-CP) node in a radio access network is provided. The second CU-CP node may comprise at least one processor and at least one memory storing instructions. The instructions may, when executed by the at least one processor, cause the second CU-CP node at least to receive a capacity poll request from one or more first CU-CP nodes in the radio access network, and send a capacity poll response to the one or more first CU-CP nodes in response to the received capacity poll request. The second CU-CP node is configured as a standby CU-CP node for the one or more first CU-CP nodes. The capacity poll response may comprise capacity information of the second CU-CP node.

Example embodiments of methods, apparatus and computer program products are also provided. Such example embodiments generally correspond to the above example embodiments, and a repetitive description thereof is omitted here for convenience.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 is a schematic block diagram illustrating a split architecture for a next generation Node-B (gNB).

FIG. 2 is a schematic block diagram illustrating an example deployment and configuration of a plurality of gNB central unit control planes (gNB-CU-CPs) according to an example embodiment of the present disclosure.

FIG. 3 is a schematic message sequence chart illustrating a process according to an example embodiment of the present disclosure.

FIG. 4 is a schematic flowchart illustrating a method according to an example embodiment of the present disclosure.

FIG. 5 is a schematic flowchart illustrating a method according to an example embodiment of the present disclosure.

FIG. 6 is a schematic block diagram illustrating an apparatus according to an example embodiment of the present disclosure.

FIG. 7 is a schematic block diagram illustrating an apparatus according to an example embodiment of the present disclosure.

FIG. 8 is a schematic block diagram illustrating a device according to an example embodiment of the present disclosure.

Throughout the drawings, same or similar reference numerals indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

In the next generation radio access network (NG-RAN), a split architecture has been introduced to divide a base station, e.g., a next generation Node-B (gNB), into a central unit (CU) and a distributed unit (DU). The CU may be further divided into a CU-control plane (CP) and a CU-user plane (UP) in order to realize a concept of cloud RAN.

FIG. 1 illustrates the split architecture of a gNB 110, with which some example embodiments of the present disclosure can be implemented. As shown in FIG. 1, the gNB 110 may include a CU-CP 112, one or more CU-UPs 114, and one or more DUs 116 (two DUs 116a, 116b are illustrated as an example). The CU-CP 112 hosts a radio resource control (RRC) protocol and a control plane part of a packet data convergence protocol (PDCP), the CU-UP 114 hosts a user plane part of the PDCP protocol and a service data adaptation protocol (SDAP), and the DU 116 hosts radio link control (RLC), medium access control (MAC) and physical (PHY) layers. The CU-CP 112 is connected to the CU-UP 114 through an E1 interface and to the DU 116 through an F1-C interface. The DU 116 is connected to the CU-UP 114 through an F1-U interface. One DU 116 is connected to only one CU-CP 112, and one CU-UP 114 is connected to only one CU-CP 112. One DU 116 can be connected to multiple CU-UPs 114 under the control of the same CU-CP 112, and one CU-UP 114 can be connected to multiple DUs 116 under the control of the same CU-CP 112.

In the split architecture, the NG-RAN function nodes may be optimally deployed at different locations based on use cases and performance requirements. In an example, the CU-CP 112 may be positioned near the DUs 116 to achieve a low latency for CP procedure such as RRC connection establishment and handover. On the other hand, the CU-UPs 114 may be centralized for example in the operator's data center, which is advantageous for cloud implementations and can provide a centralized termination point for UP traffic in dual connectivity and tight interworking scenarios. Further, an additional CU-UP 114 may be deployed near the DU 116 to provide a low latency for ultra-reliable low-latency communication (URLLC) applications.

It would be appreciated that the gNB 110 is shown as an example, and the split architecture may also be applied to other base stations, such as an evolved Node-B (eNB), a next generation eNB (ng-eNB), a beyond 5G base station, a 6G base station or a future base station.

Since the CU-CP 112 controls multiple DUs 116 and each DU 116 services one or more cells, resiliency of the CU-CP 112 is crucial to provide service continuity and avoid unexpected downtime. If the CU-CP 112 fails, it would take a long time to establish a new F1 interface from scratch, which results in mass UE release and large downtime before the communication system is reinstated. 3GPP specification does not exclude the solution that the DU 116 and/or the CU-UP 114 are connected to more than one CU-CP 112 for resiliency, but it violates current cardinality rule for the RAN architecture and would lead to other problems. For example, radio resource management (RRM) by multiple CU-CPs 112 would cause fragmentation of resources and new co-ordination overhead between the CU-CPs.

Another option is to deploy a standby CU-CP for geo-redundant resiliency of the CU-CP 112. The standby CU-CP may be activated and take over the role of the CU-CP 112 when the CU-CP 112 encounters failure. However, a single, fixed and static standby CU-CP could be a limitation in many cases. For example, the disaster impacting the active CU-CP 112 could also affect the standby CU-CP. In addition, there could be performance issues (for example, delay) in bringing the standby CU-CP to operation to fully replace the active CU-CP 112. This limitation could be mitigated to some extent by deploying multiple standby CU-CP nodes for the active CU-CP 112, but such a deployment is severely constrained by the available number of CU-CP nodes for service in the network.

Some example embodiments of the present disclosure propose a flexible configuration of multiple standby CU-CPs for a given active CU-CP, while at the same time optimizing resource allocation during handover from the active CU-CP to one or more of the configured multiple standby CU-CPs. In general, an active CU-CP can be configured with multiple standby CU-CPs, while the active CU-CP can also be configured as a standby CU-CP for multiple active CU-CPs. Such a configuration can increase the number of standby CU-CPs configurable for a given active CU-CP, thereby reducing the risk of both the active CU-CP and the single standby CU-CP being affected by the disaster, while it does not need to deploy more standby-dedicated CU-CPs in the network since an active CU-CP can also be configured as a standby node for other active CU-CPs. In some example embodiments, the active CU-CP can periodically receive capacity information from the configured multiple standby CU-CPs. The active CU-CP can dynamically allocate DUs connected to the active CU-CP to one or more of the configured standby CU-CPs based on the received capacity information and optionally other factors like geographic locations of the standby CU-CPs. It can optimize resource allocation and achieve load balance among the CU-CPs when the users are handed over from the active CU-CP to the standby CU-CPs in case of failure of the active CU-CP, thereby improving user experiences.

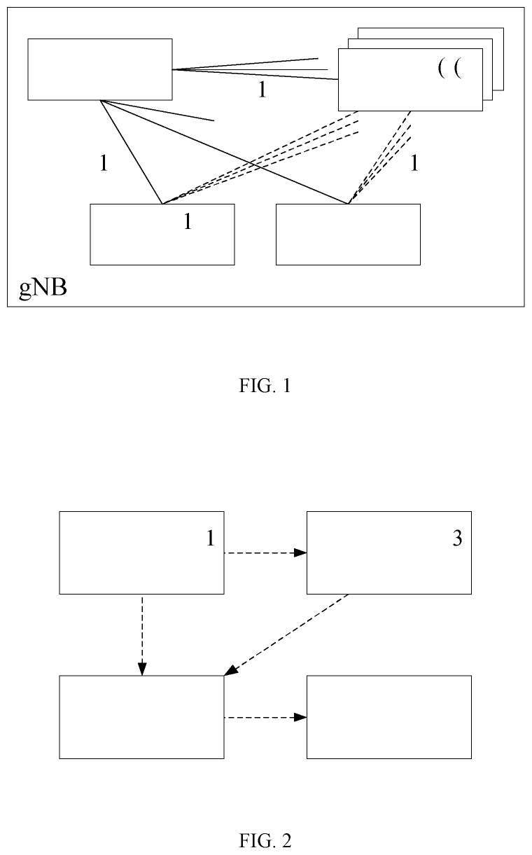

FIG. 2 is a schematic block diagram illustrating an example deployment and configuration of a plurality of gNB central unit control planes (gNB-CU-CPs) according to an example embodiment of the present disclosure. As shown in FIG. 2, four gNB-CU-CPs 112, 122, 132 and 142 are illustrated as an example, and dashed arrows are used to represent standby node configuration among the four gNB-CU-CPs. The four gNB-CU-CPs 112, 122, 132 and 142 may all be active nodes in their respective base stations, i.e., they each control one or more DUs to serve one or more cells. The network operator may configure one or more standby nodes for a given active gNB-CU-CP. In the example, the first gNB-CU-CP 112 is configured with two standby nodes, i.e., the second gNB-CU-CP 122 and the third gNB-CU-CP 132. The second gNB-CU-CP 122 is configured with the fourth gNB-CU-CP 144 as a standby node, and the third gNB-CU-CP 132 is configured with the second gNB-CU-CP 122 as a standby node. The fourth gNB-CU-CP 144 is not configured with any standby node. It would be appreciated that the multiple standby nodes configured for a given active gNB-CU-CP may be from different geographical redundant regions/locations. The standby configuration shown in FIG. 2 is also summarized in the below table 1. It can be seen that many gNB-CU-CPs are configured with one or more standby nodes, while the number of gNB-CU-CPs deployed in the network is not increased (i.e., no standby-dedicated node is deployed).

TABLE 1

| Active gNB-CU-CP | Standby gNB-CU-CP |
|---|---|
| gNB-CU-CP 112 | gNB-CU-CP 122 |
| | gNB-CU-CP 132 |
| gNB-CU-CP 122 | gNB-CU-CP 142 |
| gNB-CU-CP 132 | gNB-CU-CP 122 |
| gNB-CU-CP 142 | None |

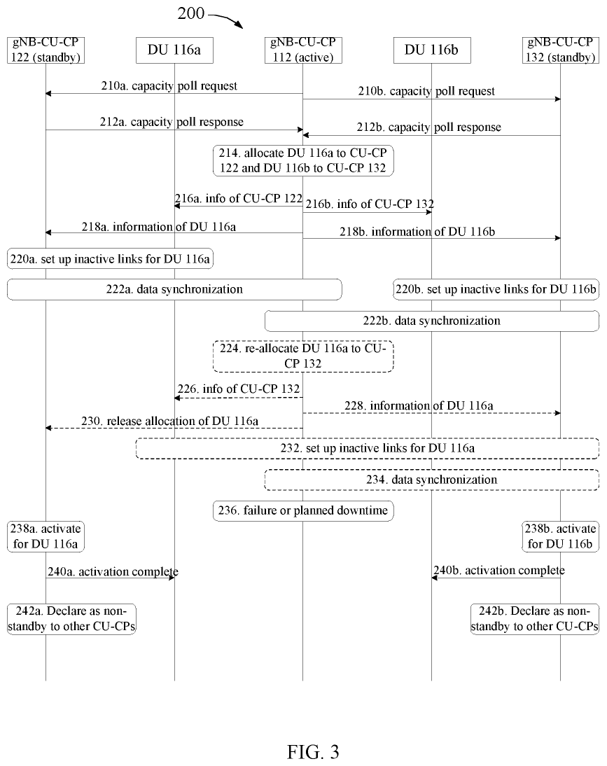

FIG. 3 illustrates a process 200 according to an example embodiment of the present disclosure. The process 200 may be performed at an active gNB-CU-CP, one or more DUs connected to the active gNB-CU-CP, and one or more standby nodes configured for the active gNB-CU-CP, e.g., at the active gNB-CU-CP 112, the DUs 116a and 116b connected to the active gNB-CU-CP 112, and the standby gNB-CU-CPs 122 and 132 configured for the active gNB-CU-CP 112 shown in FIG. 2. The active and standby gNB-CU-CPs and the DUs each may include a plurality of means, modules, components or elements for performing operations in the process 200. The means, modules, components or elements may be implemented in various manners including but not limited to software, hardware, firmware, or any combination thereof. In the process 200 shown in FIG. 3, operations represented by dashed lines may be optionally or selectively performed in some example embodiments or be omitted in other example embodiments.

As shown in FIG. 3, once the active gNB-CU-CP 112 is configured with the standby gNB-CU-CPs 122 and 132, the active gNB-CU-CP 112 may poll the standby gNB-CU-CPs 122, 132 for capacity availability at 210. For example, the active gNB-CU-CP 112 may send a capacity poll request to the standby gNB-CU-CP 122 at 210a and to the standby gNB-CU-CP 132 at 210b. In an example, the capacity poll request may include a standby capacity requirement of the active gNB-CU-CP 112. The standby capacity requirement may indicate a total number of cells served by the active gNB-CU-CP 112, or numbers of cells served by respective DUs (i.e., the DUs 116a, 116b) connected to the active gNB-CU-CP 112. Alternatively or additionally, the standby capacity requirement may indicate a number of user equipments (UEs) connected to the active gNB-CU-CP 112. The standby gNB-CU-CPs 122, 132 can know from the standby capacity requirement how many resources are needed for the active gNB-CU-CP 112 to distribute its associated DUs (and users serviced by the DUs) in case of failure.

In an example, the standby poll request may be triggered by a predetermined event. For example, if the active gNB-CU-CP 112 detects a certain likelihood of failure by running an internal failure detection algorithm or receives a failure indication from another network node or function e.g. an operation administration and maintenance (OAM) function, a RAN data analytics function (DAF) or a core network data analytics function (DAF), the active gNB-CU-CP 112 may send the capacity poll request to the standby gNB-CU-CPs 122, 132. The capacity poll request may also be sent before a planned downtime e.g. for regular maintenance or software/hardware upgrade.

In another example, the standby poll request may be periodically sent to the standby gNB-CU-CPs 122, 132, or it may include a periodicity indication indicating the standby gNB-CU-CPs 122, 132 to respond to the standby poll request periodically.

It would be appreciated that the standby gNB-CU-CPs 122, 132 each may be configured as a standby node for more than one active gNB-CU-CPs, and thus they could receive the standby poll request from the more than one active gNB-CU-CPs at different timing. The operations between the standby gNB-CU-CPs 122, 132 and the active gNB-CU-CP 112 shown in FIG. 3 are also applicable between any one of the standby gNB-CU-CPs 122, 132 and its associated active gNB-CU-CP(s).

In response to the capacity poll request, the standby gNB-CU-CPs 122, 132 may send a capacity poll response to the active gNB-CU-CP 112 at 212a, 212b, respectively. The capacity poll response may contain capacity information of the respective standby gNB-CU-CPs 122, 132, which will be described in detail below. As discussed above, the capacity poll response may be periodically sent to the active gNB-CU-CP 112.

In an example, the capacity information may indicate resources currently used at the respective standby gNB-CU-CPs 122, 132. As mentioned above, the standby gNB-CU-CPs 122, 132 can also operate in their own right as active nodes of different base stations. The currently used resources may include for example a number of cells (and cell IDs) currently supported at the standby gNB-CU-CP, a number of UEs RRC-connected to the standby gNB-CU-CP currently, slices serviced currently by the standby gNB-CU-CP, tracking area identities (TAIs) configured currently for the standby gNB-CU-CP, etc. Based on the currently used resources, the active gNB-CU-CP 112 can estimate available resources/capacity at the standby gNB-CU-CP.

In another example, the capacity information contained in the capacity poll response may indicate available resources that the standby gNB-CU-CPs 122, 132 can spare for the active gNB-CU-CP 112. For example, the capacity information may indicate resources corresponding to one hardware card equipped in the standby gNB-CU-CP for standby capacity purpose, or numbers of cells, UEs, slices and/or TAIs the standby gNB-CU-CP can additionally support.

It would be appreciated that when the capacity information contains the currently used or spare resources at the standby gNB-CU-CPs 122, 132, the capacity information received in the new capacity poll response may overwrite the capacity information received in the previous capacity poll response.

In yet another example, the capacity information contained in the capacity poll response may indicate a change (delta amount) of the resources currently used at the standby gNB-CU-CP or a change (delta amount) of the spare resources available at the standby gNB-CU-CP. Before reporting the change of the used or spare resources to the active gNB-CU-CP 112, the standby gNB-CU-CPs 122, 132 may report an initial amount of the used or spare resources to the active gNB-CU-CP 112, for example when the standby gNB-CU-CPs 122, 132 are configured as standby nodes for the active gNB-CU-CP 112. In a case where the capacity poll response is periodically sent to the active gNB-CU-CP 112, the standby gNB-CU-CPs 122, 132 may report the initial amount of the used or spare resources before or in the first capacity poll response and then report the change of the used or spare resources in subsequent capacity poll responses. The change of the used or spare resources may include an increased or reduced amount of the currently used or spare resources relative to the used or spare resources associated with the initial reporting or the previous reporting. Then the active gNB-CU-CP 112 can obtain the currently used or spare resources by accumulating the initial amount of the used or spare resources and the latest change amount of the used or spare resources, or by accumulating the initial amount and all the received change amounts.

It would be appreciated that when the standby gNB-CU-CP 122 or 132 is configured as a standby node for multiple active gNB-CU-CPs, it can report the capacity information to all of the multiple active gNB-CU-CPs that initiate the polling, but eventually the standby gNB-CU-CP 122 or 132 may be activated for one of the multiple active gNB-CU-CPs.

At 214, the active gNB-CU-CP 112 may allocate DUs 116a, 116b connected to the active gNB-CU-CP 112 to the standby gNB-CU-CPs 122, 132 at least based on the capacity information received from the standby gNB-CU-CPs 122, 132. The active gNB-CU-CP 112 may compare loads at the DUs 116a, 116b with available capacity of the standby gNB-CU-CPs 122, 132 and allocate each DU to a standby gNB-CU-CP which have enough available capacity for traffics of the allocated DU. The active gNB-CU-CP 112 may also determine the allocation for each DU taking into consideration of load balance between the gNB-CU-CPs in the network.

In some example embodiments, the active gNB-CU-CP 112 may also determine allocation of DUs 116a, 116b to the standby gNB-CU-CPs 122, 132 further based on other factors like geographic locations of the standby gNB-CU-CPs 122, 132. For example, the active gNB-CU-CP 112 may allocate each of the DUs 116a, 116b to a standby gNB-CU-CP deployed near the DU to achieve a low latency for traffics of the DU.

The active gNB-CU-CP 112 may run an internal allocation algorithm to determine the allocation for the DUs 116a, 116b. The internal allocation algorithm may receive for example the capacity information and locations of the standby gNB-CU-CPs, the traffic load and locations of the DUs, and optionally additional data as input, and it calculates an allocation solution for the DUs which obtains a high score in terms of for example load balance, latency and/or other performance metrics. For convenience of description, it is assumed in the example shown in FIG. 3 that the first DU 116a is allocated to the standby gNB-CU-CP 122 and the second DU 116b is allocated to the standby gNB-CU-CP 132.

At 216, the active gNB-CU-CP 112 may provide information of the standby gNB-CU-CP to the DU(s) allocated to the standby gNB-CU-CP. In the example shown in FIG. 3, the active gNB-CU-CP 112 may provide information of the standby gNB-CU-CP 122 to the first DU 116a at 216a and information of the standby gNB-CU-CP 132 to the second DU 116b at 216b. The information of the standby gNB-CU-CP may include for example an IP address of the standby gNB-CU-CP. In an example, the information of the standby gNB-CU-CP may be conveyed to the DU(s) via an F1 application protocol (F1AP) message e.g. gNB CU Config Update.

At 218, the active gNB-CU-CP 112 may provide information of the DU(s) to the standby gNB-CU-CP which the DU(s) is allocated to. In the example shown in FIG. 3, the active gNB-CU-CP 112 may provide information of the first DU 116a to the standby gNB-CU-CP 122 at 218a and information of the second DU 116b to the standby gNB-CU-CP 132 at 218b. The information of the DU may include for example identity of the DU, identity of the CU-CP to which the DU is connected, and core network function nodes like access and mobility management function (AMF) associated with the DU. In an example, the information of the DU may be conveyed to the standby gNB-CU-CP via an Xn application protocol (XnAP) message e.g. RAN Configuration Update.

In an example embodiment, the active gNB-CU-CP 112 may also provide downtime information to the standby gNB-CU-CPs 122, 132 at 218 if the active gNB-CU-CP 112 is aware of the downtime. For example, if the active gNB-CU-CP 112 is configured with a planned downtime or it receives a downtime indication from the core network, the active gNB-CU-CP 112 may provide downtime information to the standby gNB-CU-CPs 122, 132 at 218. The downtime information may indicate when and how long the standby gNB-CU-CPs 122, 132 would be activated to operate as an active node for the allocated DUs.

At 220, the standby gNB-CU-CPs 122, 132 may set up inactive links for the DUs allocated to the standby gNB-CU-CPs 122, 132. In the example shown in FIG. 3, the standby gNB-CU-CP 122 may set up inactive links for the first DU 116a at 220a, and the standby gNB-CU-CP 132 may set up inactive links for the second DU 116b at 220b. For example, the standby gNB-CU-CPs 122, 132 may set up an inactive stream control transmission protocol (SCTP) association with the allocated DU, an inactive N2 interface with the AMF associated with the allocated DU, and optionally other inactive links for the allocated DU.

At 222, the standby gNB-CU-CPs 122, 132 may start data synchronization with the active gNB-CU-CP 112. In the example shown in FIG. 3, the standby gNB-CU-CP 122 may periodically receive from the active gNB-CU-CP 112 synchronization data relating to the first DU 116a allocated to the standby gNB-CU-CP 122 at 222a, and the standby gNB-CU-CP 132 may periodically receive from the active gNB-CU-CP 112 synchronization data relating to the second DU 116b allocated to the standby gNB-CU-CP 132 at 222b. With the synchronization data, the standby gNB-CU-CPs 122, 132 can be activated to serve the allocated DUs 116a, 116b replacing the active gNB-CU-CP 112 when the active gNB-CU-CP 112 is out of service.

As discussed above, the active gNB-CU-CP 112 may periodically receive the capacity information from the standby gNB-CU-CPs 122, 132. If the received capacity information changes, e.g., more UEs are RRC connected to the standby gNB-CU-CPs 122, 132 or some UEs are disconnected from the standby gNB-CU-CPs 122, 132, and/or if the traffic load at the DUs 116a, 116b changes, the active gNB-CU-CP 112 may trigger re-allocation of the DUs 116a, 116b. For convenience of description, it is assumed in the example shown in FIG. 3 that the active gNB-CU-CP 112 re-allocates the first DU 116a to the standby gNB-CU-CP 132 at 224. Then the active gNB-CU-CP 112 may provide information of the standby gNB-CU-CP 132 to the first DU 116a at 226 and provide information of the first DU 116a to the standby gNB-CU-CP 132 at 228. The active gNB-CU-CP 112 may also indicate to the standby gNB-CU-CP 122 which the first DU 116a is previously allocated to that the allocation of the first DU 116a to the standby gNB-CU-CP 122 is released at 230. In response to the allocation release indication, the standby gNB-CU-CP 122 may remove the inactive SCTP association and other links for the first DU 116a.

The standby gNB-CU-CP 132 which the first DU 116a is newly allocated to may set up inactive links for the first DU 116a at 232 and start data synchronization with the active gNB-CU-CP 112 to receive synchronization data relating to the first DU 116a at 234. It would be appreciated that the operations 224, 226, 228, 232, 234 may be similar to the operations 214, 216, 218, 220, 222 discussed above and a repetitive description of details of these operations is omitted here for convenience.

The active gNB-CU-CP 112 may encounter an unexpected failure or a planned downtime at 236 and it cannot serve the DUs 116a, 116b any longer. The active gNB-CU-CP 112 may send a failure indication to the standby gNB-CU-CPs 122, 132 before it fails, or the standby gNB-CU-CPs 122, 132 may detect the failure of the active gNB-CU-CP 112 via an XnAP message. For example, the standby gNB-CU-CPs 122, 132 may periodically transmit an XnAP message to the active gNB-CU-CP 112 and monitor for a response from the active gNB-CU-CP 112. If no response is received from the active gNB-CU-CP 112 for predetermined times, the standby gNB-CU-CPs 122, 132 can determine that the active gNB-CU-CP 112 is in failure. Then the standby gNB-CU-CPs 122, 132 which have been allocated with one or more DUs connected to the active gNB-CU-CP 112 may be activated at 238 to operate as an active CU-CP node for the allocated one or more DUs replacing the active gNB-CU-CP 112. Here it is assumed that the first DU 116a is allocated to the standby gNB-CU-CP 122 and the second DU 116b is allocated to the standby gNB-CU-CP 132. The standby gNB-CU-CP 122 may be activated for the first DU 116a at 238a and the standby gNB-CU-CP 132 may be activated for the second DU 116b at 238b. It is worthy noted that the standby gNB-CU-CPs 122, 132 may be active nodes of different RAN instances in their own right as mentioned above, and in the activation operation 238 the standby gNB-CU-CPs 122, 132 may be merely activated for the DUs 116a, 116b connected to the active gNB-CU-CP 112.

When the standby gNB-CU-CPs 122, 132 are activated, the standby gNB-CU-CPs 122, 132 may send an activation complete message to the DUs 116a, 116b at 240a and 240b, respectively. The DUs 116a, 116b can know from the activation complete message that the standby gNB-CU-CPs 122, 132 have taken over the role of the active gNB-CU-CP 112. Then the DUs 116a, 116b may forward uplink UE data to and receive downlink data from the standby (now active) gNB-CU-CPs 122, 132, respectively.

In an example embodiment, if the standby gNB-CU-CPs 122, 132 each are further configured as a standby node for other active gNB-CU-CPs in addition to the active gNB-CU-CP 112, the standby gNB-CU-CPs 122, 132 may declare as a non-standby node to one or more of the other active gNB-CU-CPs at 242a and 242b, respectively. For example, after taking over the DUs 116a, 116b, the standby gNB-CU-CPs 122, 132 do not have enough capacity available for one or more other active gNB-CU-CPs. Then the standby gNB-CU-CPs 122, 132 may declare as a non-standby node for the one or more other active gNB-CU-CPs. The standby gNB-CU-CPs 122, 132 may further remove inactive SCTP associations and other links established for DUs associated with the one or more other active gNB-CU-CPs. In an example embodiment, the operations 242a, 242b may be omitted, and the standby gNB-CU-CPs 122, 132 may report capacity information as usual to the other active gNB-CU-CPs. Since the standby gNB-CU-CPs 122, 132 have smaller capacity availability than before, the other active gNB-CU-CPs may release allocation of DUs to the standby gNB-CU-CPs 122, 132 and/or mark the standby gNB-CU-CPs 122, 132 as non-standby nodes.

In the process 200 discussed above, the active CU-CP 112 can periodically receive capacity information from multiple standby CU-CPs and dynamically allocate DUs connected to the active CU-CP 112 to one or more of the multiple standby CU-CPs based on the received capacity information and optionally other factors like geographic locations of the multiple standby CU-CPs. It can optimize resource allocation and achieve load balance among the CU-CPs for service in the network, thereby improving user experience.

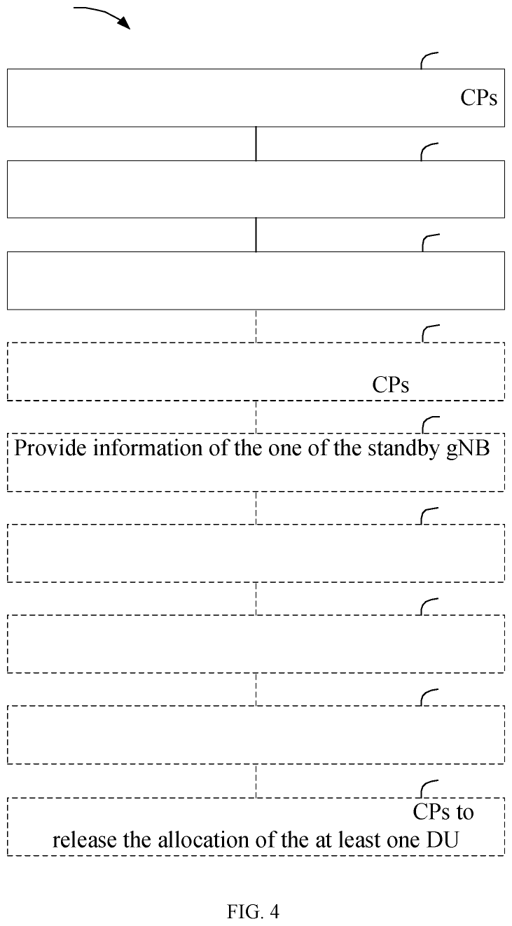

FIG. 4 is a schematic flowchart illustrating a method 300 according to an example embodiment of the present disclosure. The method 300 may be performed at an active gNB-CU-CP like the active gNB-CU-CP 112 discussed above. Steps illustrated in dashed-line blocks in FIG. 4 may represent optional steps which can be omitted in some example embodiments. In some example embodiments, the method 300 may further include one or more steps that are performed at the active gNB-CU-CP 112 as described above with respect to FIG. 3. It would also be appreciated that details of some steps in the method 300 have been discussed above with respect to FIG. 3 and the method 300 will be described here in a simple manner.

As shown in FIG. 4, the active gNB-CU-CP 112 may send a capacity poll request to one or more gNB-CU-CPs which are configured as standby nodes for the active gNB-CU-CP 112 at 310, receive from the one or more standby gNB-CU-CPs a capacity poll response comprising capacity information of the one or more standby gNB-CU-CPs at 320, and allocate at least one DU associated with the active gNB-CU-CP 112 to one of the one or more standby gNB-CU-CPs at least based on the capacity information of the one or more standby gNB-CU-CPs at 330.

In an example embodiment, at least one of the one or more standby gNB-CU-CPs, which is configured as a standby node for the active gNB-CU-CP 112, may also operate as active gNB-CU-CPs in its own base station different from a base station including the active gNB-CU-CP 112.

In an example embodiment, the active gNB-CU-CP 112 may allocate the at least one DU to the one of the one or more standby gNB-CU-CPs at least further based on geographic locations of the one or more standby gNB-CU-CPs.

In an example embodiment, the capacity poll request may indicate a standby capacity requirement of the active gNB-CU-CP 112.

In an example embodiment, the capacity information received in the capacity poll response may indicate resources currently used at the one or more standby gNB-CU-CPs or spare resources available at the one or more standby gNB-CU-CPs.

In an example embodiment, the capacity poll request may be periodically sent to the one or more standby gNB-CU-CPs, or the capacity poll request may include a periodicity indication indicating the one or more standby gNB-CU-CPs to report the capacity information periodically.

In an example embodiment, the capacity poll response may be periodically received from the one or more standby gNB-CU-CPs.

In an example embodiment, the capacity information received in the capacity poll response may indicate a change of resources currently used at the one or more standby gNB-CU-CPs or a change of spare resources available at the one or more standby gNB-CU-CPs.

In an example embodiment, the active gNB-CU-CP 112 may provide information of the at least one DU to the one of the one or more standby gNB-CU-CPs at 340, and provide information of the one of the one or more standby gNB-CU-CPs to the at least one DU at 350.

In an example embodiment, the active gNB-CU-CP 112 may further provide downtime information to the one of the one or more standby gNB-CU-CPs at the step 340. The downtime information may indicate when and how long the one of the one or more standby gNB-CU-CPs is to be activated as an active gNB-CU-CP for the at least one DU.

In an example embodiment, the one or more standby gNB-CU-CPs configured for the active gNB-CU-CP 112 include a plurality of standby gNB-CU-CPs, and the active gNB-CU-CP 112 may re-allocate, at 360, the at least one DU associated with the active gNB-CU-CP 112 to another one of the plurality of standby gNB-CU-CPs in response to change in at least one of the following: the capacity information of the plurality of standby gNB-CU-CPs, or capacity information of one or more DUs associated with the active gNB-CU-CP 112. The active gNB-CU-CP 112 may further provide information of the at least one DU to the another one of the plurality of standby gNB-CU-CPs at 370, and provide information of the another one of the plurality of standby gNB-CU-CPs to the at least one DU at 380.

In an example embodiment, the active gNB-CU-CP 112 may further inform the one of the plurality of standby gNB-CU-CPs which the at least one DU was previously allocated to that the allocation of the at least one DU is released at 390.

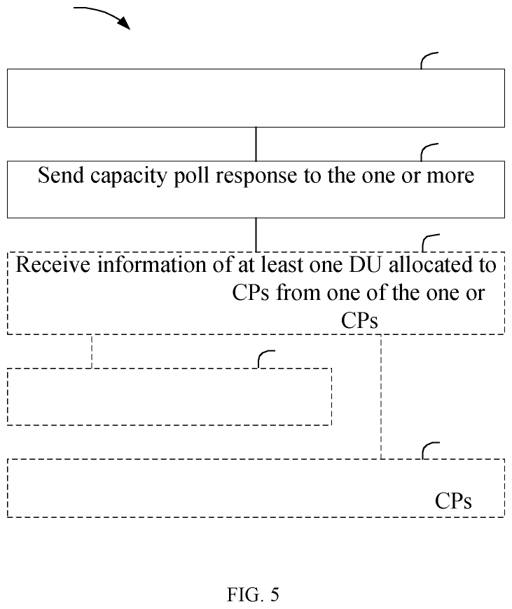

FIG. 5 is a schematic flowchart illustrating a method 400 according to an example embodiment of the present disclosure. The method 400 may be performed at a standby gNB-CU-CP like the standby gNB-CU-CP 122 or 132 discussed above. In some example embodiments, the method 400 may further include one or more steps that are performed at the standby gNB-CU-CP 122 or 132 as described above with respect to FIG. 3. It would also be appreciated that details of some steps in the method 400 have been discussed above with respect to FIG. 3 and the method 400 will be described here in a simple manner. For convenience of description, the method 400 will be described below with respect to the standby gNB-CU-CP 122.

As shown in FIG. 5, the standby gNB-CU-CP 122 may receive a capacity poll request from one or more active gNB-CU-CPs at 410, and send a capacity poll response to the one or more active gNB-CU-CPs in response to the received capacity poll request at 420. The standby gNB-CU-CP 122 is configured as a standby node for the one or more active gNB-CU-CPs, and the capacity poll response may contain capacity information of the standby gNB-CU-CP 122.

In an example embodiment, the capacity poll request may indicate a standby capacity requirement of the one or more active gNB-CU-CPs.

In an example embodiment, the capacity information of the standby gNB-CU-CP 122 may indicate resources currently used at the standby gNB-CU-CP 122 or spare resources available at the standby gNB-CU-CP 122.

In an example embodiment, the capacity poll request may be periodically received from the one or more active gNB-CU-CPs or the capacity poll request may include a periodicity indication indicating the standby gNB-CU-CP 122 to send the capacity poll response periodically.

In an example embodiment, the capacity poll response may be periodically sent to the one or more active gNB-CU-CPs.

In an example embodiment, the capacity information included in the capacity poll response may indicate a change of resources currently used at the standby gNB-CU-CP 122 or a change of spare resources available at the standby gNB-CU-CP 122.

In an example embodiment, the standby gNB-CU-CP 122 may receive at 430 from one of the one or more active gNB-CU-CPs, information of at least one DU associated with the one of the one or more active gNB-CU-CPs allocated to the standby gNB-CU-CP 122.

In an example embodiment, the standby gNB-CU-CP 122 may further receive at 430 downtime information from the one of the one or more active gNB-CU-CPs. The downtime information may indicate when and how long the standby gNB-CU-CP 122 is to be activated as an active node for the at least one DU allocated to the standby gNB-CU-CP 122.

In an example embodiment, the standby gNB-CU-CP 122 may receive at 440 from the one of the one or more active gNB-CU-CPs, an indication that the allocation of the at least one DU associated with the one of the one or more active gNB-CU-CPs is released.

In an example embodiment, if the standby gNB-CU-CP 122 is activated as an active node for the at least one DU allocated to the standby gNB-CU-CP 122 in response to failure of the one of the one or more active gNB-CU-CPs, the standby gNB-CU-CP 122 may declare at 450 as a non-standby node to at least one of the others of the one or more active gNB-CU-CPs.

In the above example embodiments, the standby gNB-CU-CP 122 may operate as an active node in its own base station different from one or more base stations including the one or more active gNB-CU-CPs.

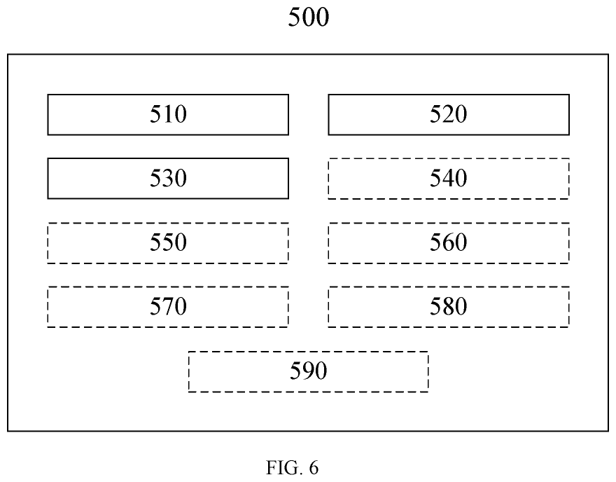

FIG. 6 is a schematic block diagram illustrating an apparatus 500 according to an example embodiment of the present disclosure. The apparatus 500 may be implemented at a network node like the active gNB-CU-CP 112 to perform operations relating to the active gNB-CU-CP 112 as discussed above. Since the operations relating to the active gNB-CU-CP 112 have been discussed in detail with reference to FIGS. 2-5, the blocks of the apparatus 500 will be described briefly here and details thereof may refer to the above description.

Referring to FIG. 6, the apparatus 500 may include a first means 510 for sending a capacity poll request from the active gNB-CU-CP 112 to one or more gNB-CU-CPs which are configured as standby nodes for the active gNB-CU-CP 112, a second means 520 for receiving from the one or more standby gNB-CU-CPs a capacity poll response comprising capacity information of the one or more standby gNB-CU-CPs, and a third means 530 for allocating at least one DU associated with the active gNB-CU-CP 112 to one of the one or more standby gNB-CU-CPs at least based on the capacity information of the one or more standby gNB-CU-CPs.

In an example embodiment, at least one of the one or more standby gNB-CU-CPs, which is configured as a standby node for the active gNB-CU-CP 112, may also operate as an active gNB-CU-CP in its own base station different from a base station including the active gNB-CU-CP 112.

In an example embodiment, the third means 530 may allocate the at least one DU to the one of the one or more standby gNB-CU-CPs at least further based on geographic locations of the one or more standby gNB-CU-CPs.

In an example embodiment, the capacity poll request may indicate a standby capacity requirement of the active gNB-CU-CP 112.

In an example embodiment, the capacity information received in the capacity poll response may indicate resources currently used at the one or more standby gNB-CU-CPs or spare resources available at the one or more standby gNB-CU-CPs.

In an example embodiment, the first means 510 may send the capacity poll request periodically to the one or more standby gNB-CU-CPs. In another example embodiment, the capacity poll request may include a periodicity indication indicating the one or more standby gNB-CU-CPs to report the capacity information periodically.

In an example embodiment, the second means 520 may receive the capacity poll response periodically from the one or more standby gNB-CU-CPs.

In an example embodiment, the capacity information received in the capacity poll response may indicate a change of resources currently used at the one or more standby gNB-CU-CPs or a change of spare resources available at the one or more standby gNB-CU-CPs.

In an example embodiment, the apparatus 500 may further comprise a fourth means 540 for providing information of the at least one DU to the one of the one or more standby gNB-CU-CPs, and a fifth means 550 for providing information of the one of the one or more standby gNB-CU-CPs to the at least one DU.

In an example embodiment, the fourth means 540 may further provide downtime information along with the information of the at least one DU to the one of the one or more standby gNB-CU-CPs. The downtime information may indicate when and how long the one of the one or more standby gNB-CU-CPs is to be activated as an active gNB-CU-CP for the at least one DU.

In an example embodiment, the one or more standby gNB-CU-CPs configured for the active gNB-CU-CP 112 include a plurality of standby gNB-CU-CPs, and the apparatus 500 may further comprise a sixth means 560 for re-allocating the at least one DU associated with the active gNB-CU-CP 112 to another one of the plurality of standby gNB-CU-CPs in response to change in at least one of the following: the capacity information of the plurality of standby gNB-CU-CPs, or capacity information of one or more DUs associated with the active gNB-CU-CP 112. The apparatus 500 may further comprise a seventh means 570 for providing information of the at least one DU to the another one of the plurality of standby gNB-CU-CPs, and an eighth means 580 for providing information of the another one of the plurality of standby gNB-CU-CPs to the at least one DU.

In an example embodiment, the apparatus 500 may further comprise a ninth means 590 for informing the one of the plurality of standby gNB-CU-CPs which the at least one DU was previously allocated to that the allocation of the at least one DU is released.

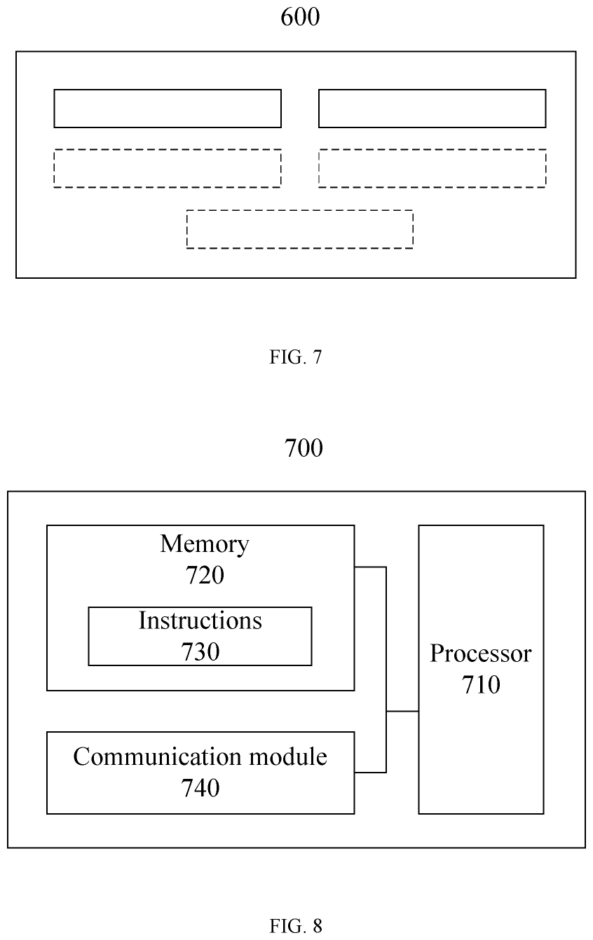

FIG. 7 is a schematic block diagram illustrating an apparatus 600 according to an example embodiment of the present disclosure. The apparatus 600 may be implemented at a network node like the standby gNB-CU-CPs 122, 132 to perform operations relating to the standby gNB-CU-CPs 122, 132 as discussed above. Since the operations relating to the standby gNB-CU-CPs 122, 132 have been discussed in detail with reference to FIGS. 2-5, the blocks of the apparatus 600 will be described briefly here and details thereof may refer to the above description. For convenience of description, the apparatus 600 will be described below with respect to the standby gNB-CU-CP 122.

As shown in FIG. 7, the apparatus 600 may comprise a first means 610 for receiving at the standby gNB-CU-CP 122 a capacity poll request from one or more active gNB-CU-CPs, and a second means 620 for sending a capacity poll response to the one or more active gNB-CU-CPs in response to the received capacity poll request. The standby gNB-CU-CP 122 is configured as a standby node for the one or more active gNB-CU-CPs, and the capacity poll response may contain capacity information of the standby gNB-CU-CP 122.

In an example embodiment, the capacity poll request may indicate a standby capacity requirement of the one or more active gNB-CU-CP.

In an example embodiment, the capacity information of the standby gNB-CU-CP 122 may indicate resources currently used at the standby gNB-CU-CP 122 or spare resources available at the standby gNB-CU-CP 122.

In an example embodiment, the first means 610 may receive the capacity poll request periodically from the one or more active gNB-CU-CPs. In another example embodiment, the capacity poll request may include a periodicity indication indicating the standby gNB-CU-CP 122 to send the capacity poll response periodically.

In an example embodiment, the second means 620 may send the capacity poll response periodically to the one or more active gNB-CU-CPs.

In an example embodiment, the capacity information included in the capacity poll response may indicate a change of resources currently used at the standby gNB-CU-CP 122 or a change of spare resources available at the standby gNB-CU-CP 122.

In an example embodiment, the apparatus 600 may further comprise a third means 630 for receiving from one of the one or more active gNB-CU-CPs, information of at least one DU associated with the one of the one or more active gNB-CU-CPs allocated to the standby gNB-CU-CP 122.

In an example embodiment, the third means 630 may further receive downtime information from the one of the one or more active gNB-CU-CPs. The downtime information may indicate when and how long the standby gNB-CU-CP 122 is to be activated as an active node for the at least one DU allocated to the standby gNB-CU-CP 122.

In an example embodiment, the apparatus 600 may further comprise a fourth means 640 for receiving from the one of the one or more active gNB-CU-CPs, an indication that the allocation of the at least one DU associated with the one of the one or more active gNB-CU-CPs is released.

In an example embodiment, the apparatus 600 may further comprise a fifth means 650 for declaring the standby gNB-CU-CP 122 as a non-standby node to at least one of the others of the one or more active gNB-CU-CPs in a case where the standby gNB-CU-CP 122 is activated as an active node for the at least one DU allocated to the standby gNB-CU-CP 122 in response to failure of the one of the one or more active gNB-CU-CPs.

In the above example embodiments, the standby gNB-CU-CP 122 may operate as an active node in its own base station different from one or more base stations including the one or more active gNB-CU-CPs.

FIG. 8 is a schematic block diagram illustrating a device 700 according to an example embodiment of the present disclosure. The device 700 may be implemented as an active gNB-CU-CP like the active gNB-CU-CP 112 discussed above or a standby gNB-CU-CP like the standby gNB-CU-CP 122 or 132 discussed above.

As shown in FIG. 8, the device 700 may comprise one or more processors 710, one or more memories 720 coupled to the processors 710, and one or more communication modules 730 coupled to the processors 710. The one or more memories 720 may have computer executable instructions 730 stored therein. The instructions 730 may, when executed by the one or more processors 710, cause the device 700 to implement a procedure discussed above with respect to the gNB-CP-CU 112, 122 or 132. The one or more communication modules 730 may implement any communication interface that is necessary for communication with other network nodes or user equipments. If necessary, the one or more communication modules 730 may include at least one antenna to facilitate radio communication with other network nodes or user equipments.

The one or more processors 710 may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 710 may be configured to control other elements of the devices 700 and operate in cooperation with them to implement the procedures discussed above with respect to the gNB-CP-CU 112, 122 or 132.

The one or more memories 720 may include at least one storage medium in various forms, such as a volatile memory and/or a non-volatile memory. The volatile memory may include but not limited to for example a random access memory (RAM) or a cache. The non-volatile memory may include but not limited to for example a read only memory (ROM), a hard disk, a flash memory, and the like. Further, the one or more memories 720 may include but not limited to an electric, a magnetic, an optical, an electromagnetic, an infrared, or a semiconductor system, apparatus, or device or any combination of the above.

It would be understood that blocks in the drawings may be implemented in various manners, including software, hardware, firmware, or any combination thereof. In some embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Some exemplary embodiments further provide computer program code or instructions which, when executed by one or more processors, may cause a device or apparatus to perform the procedures described above. The computer program code or instructions for carrying out procedures of the exemplary embodiments may be written in any combination of one or more programming languages. The computer program code or instructions may be provided to one or more processors or controllers of a general purpose computer, special purpose computer, or other programmable data processing apparatus, such that the program code, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine or entirely on the remote machine or server.

Some exemplary embodiments further provide a computer program product or a computer readable medium having the computer program code or instructions stored therein. The computer readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

1.-50. (canceled)

51. A first central unit control plane (CU-CP) node in a radio access network comprising:
at least one processor; and
at least one memory storing instructions that, when executed by the at least one processor, cause the first CU-CP node to:
send a capacity poll request to one or more second CU-CP nodes in the radio access network configured as standby CU-CP nodes for the first CU-CP node;
receive a capacity poll response from the one or more second CU-CP nodes, the capacity poll response comprising capacity information of the one or more second CU-CP nodes;
allocate at least one distributed unit associated with the first CU-CP node to one of the one or more second CU-CP nodes at least based on the capacity information of the one or more second CU-CP nodes and based on geographic locations of the plurality of second CU-CP nodes;
re-allocate the at least one distributed unit associated with the first CU-CP node to another one of the plurality of second CU-CP nodes in response to change in the following: the capacity information of the plurality of second CU-CP nodes, and capacity information of one or more distributed units associated with the first CU-CP node;
provide information of the at least one distributed unit to the another one of the plurality of second CU-CP nodes;
provide information of the another one of the plurality of second CU-CP nodes to the at least one distributed unit; and
inform the one of the plurality of second CU-CP nodes that the allocation of the at least one distributed unit associated with the first CU-CP node is released, wherein at least one of the one or more second CU-CP nodes configured as the standby CU-CP nodes for the first CU-CP node operates as an active CU-CP node in a second base station different from a first base station including the first CU-CP node.

52. The first CU-CP node of claim 51, wherein the capacity poll request indicates a standby capacity requirement of the first CU-CP node.

53. The first CU-CP node of claim 52, wherein the capacity information received in the capacity poll response indicates resources currently used at the one or more second CU-CP nodes or spare resources available at the one or more second CU-CP nodes.

54. The first CU-CP node of claim 53, wherein the capacity poll request is periodically sent to the one or more second CU-CP nodes.

55. The first CU-CP node of claim 53, wherein the capacity poll request includes a periodicity indication indicating the one or more second CU-CP nodes to report the capacity information periodically.

56. The first CU-CP node of claim 55, wherein the capacity poll response is periodically received from the one or more second CU-CP nodes.

57. The first CU-CP node of claim 56, wherein the capacity information received in the capacity poll response indicates a change of resources currently used at the one or more second CU-CP nodes or a change of spare resources available at the one or more second CU-CP nodes.

58. A system comprising:
a first central unit control plane (CU-CP) node in a radio access network;
at least one processor; and
at least one memory storing instructions that, when executed by the at least one processor, cause the first CU-CP node to:
send a capacity poll request to one or more second CU-CP nodes in the radio access network configured as standby CU-CP nodes for the first CU-CP node;
receive a capacity poll response from the one or more second CU-CP nodes, the capacity poll response comprising capacity information of the one or more second CU-CP nodes;
allocate at least one distributed unit associated with the first CU-CP node to one of the one or more second CU-CP nodes at least based on the capacity information of the one or more second CU-CP nodes and based on geographic locations of the plurality of second CU-CP nodes;
re-allocate the at least one distributed unit associated with the first CU-CP node to another one of the plurality of second CU-CP nodes in response to change in the following: the capacity information of the plurality of second CU-CP nodes, and capacity information of one or more distributed units associated with the first CU-CP node;
provide information of the at least one distributed unit to the another one of the plurality of second CU-CP nodes;
provide information of the another one of the plurality of second CU-CP nodes to the at least one distributed unit; and
inform the one of the plurality of second CU-CP nodes that the allocation of the at least one distributed unit associated with the first CU-CP node is released, wherein at least one of the one or more second CU-CP nodes configured as the standby CU-CP nodes for the first CU-CP node operates as an active CU-CP node in a second base station different from a first base station including the first CU-CP node.

59. The system of claim 58, wherein the capacity poll request indicates a standby capacity requirement of the first CU-CP node.

60. The system of claim 59, wherein the capacity information received in the capacity poll response indicates resources currently used at the one or more second CU-CP nodes or spare resources available at the one or more second CU-CP nodes.

61. The system of claim 60, wherein the capacity poll request is periodically sent to the one or more second CU-CP nodes.

62. The system of claim 60, wherein the capacity poll request includes a periodicity indication indicating the one or more second CU-CP nodes to report the capacity information periodically.

63. The system of claim 62, wherein the capacity poll response is periodically received from the one or more second CU-CP nodes.

64. The system of claim 63, wherein the capacity information received in the capacity poll response indicates a change of resources currently used at the one or more second CU-CP nodes or a change of spare resources available at the one or more second CU-CP nodes.

65. A method comprising:
sending, by a first central unit control plane (CU-CP) node in a radio access network a capacity poll request to one or more second CU-CP nodes in the radio access network configured as standby CU-CP nodes for the first CU-CP node;
receiving, by the first CU-CP, a capacity poll response from the one or more second CU-CP nodes, the capacity poll response comprising capacity information of the one or more second CU-CP nodes;
allocating, by the first CU-CP, at least one distributed unit associated with the first CU-CP node to one of the one or more second CU-CP nodes at least based on the capacity information of the one or more second CU-CP nodes and based on geographic locations of the plurality of second CU-CP nodes;
re-allocating, by the first CU-CP, the at least one distributed unit associated with the first CU-CP node to another one of the plurality of second CU-CP nodes in response to change in the following: the capacity information of the plurality of second CU-CP nodes, and capacity information of one or more distributed units associated with the first CU-CP node;
providing, by the first CU-CP, information of the at least one distributed unit to the another one of the plurality of second CU-CP nodes;
providing, by the first CU-CP, information of the another one of the plurality of second CU-CP nodes to the at least one distributed unit; and
informing, by the first CU-CP, the one of the plurality of second CU-CP nodes that the allocation of the at least one distributed unit associated with the first CU-CP node is released, wherein at least one of the one or more second CU-CP nodes configured as the standby CU-CP nodes for the first CU-CP node operates as an active CU-CP node in a second base station different from a first base station including the first CU-CP node.

66. The method of claim 65, wherein the capacity poll request indicates a standby capacity requirement of the first CU-CP node.

67. The method of claim 66, wherein the capacity information received in the capacity poll response indicates resources currently used at the one or more second CU-CP nodes or spare resources available at the one or more second CU-CP nodes.

68. The method of claim 67, wherein the capacity poll request is periodically sent to the one or more second CU-CP nodes.

69. The method of claim 68, wherein the capacity poll request includes a periodicity indication indicating the one or more second CU-CP nodes to report the capacity information periodically.

70. The method of claim 69, wherein the capacity poll response is periodically received from the one or more second CU-CP nodes; and
wherein the capacity information received in the capacity poll response indicates a change of resources currently used at the one or more second CU-CP nodes or a change of spare resources available at the one or more second CU-CP nodes.
